(19) United States
(12) Patent Application Publication
(10) Pub. No.: US 2007/0157322 A1
(43) Pub. Date: Jul. 5, 2007

(54) Installation for protected access to a digital content

(76) Inventor: Stephane Onno, Saint Gregoire (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/635,724

(22) Filed: Dec. 7, 2006

(30) Foreign Application Priority Data
Dec. 30, 2005 (EP) 05292826.4

(51) Int. Cl. H04L 9/32; H04L 9/00; G06K 9/00

(52) U.S. Cl. 726/28; 726/4; 713/176; 380/44

(57) ABSTRACT

The installation for protected access to a digital content comprises:

a candidate user identification means,

a lock adapted to lock or unlock an access gate to a restricted area containing at least a processing device for processing a digital content,

a bridge server adapted to allow or refuse a candidate content intended to be downloaded by a processing device to be provided to a user, and

a gateway server adapted to implement rules for driving the bridge server and the lock to allow or refuse the entrance of a candidate user or a candidate content into the restricted area depending on the users and the digital content already entered in the restricted area.

### FIELD OF THE INVENTION

The present invention concerns an installation for protected access to a digital content.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Multimedia or digital content, such as the content of video and/or audio files, is extremely valuable and needs to be protected against theft for avoiding to be stolen by unauthorized copying.

Various methods for protecting digital content are known. All of them provide some data which is added to the digital content and often the digital content is encrypted or scrambled before being stored or transmitted. Keys are necessary to access the digital content. Nevertheless, even when the digital content is accessed it is desirable that the digital content cannot be copied, modified or resent. Thus, various protective measures are normally inserted into the content to prevent such processing of the digital content.

In professional workshops, it is often necessary to process the clear or raw digital content meaning without any protective data inserted therein.

In particular, efficient processing treatment requires one to deal with clear content, which implies that protection needs to be temporary removed.

For example, powerful video processing for graphics effects or colour correction need multiple operations. For each operation, a descrambling/processing/scrambling of the data corresponding to the content need to be performed which lowers the performance of the processing. Otherwise, if the content remains in clear form between operations, the risk to have the content stolen or maliciously modified is increased.

The object of the invention is to provide a solution to the risk that the digital content be stolen during processing.

To this end, the invention provides an installation according to claim 1.

Additional features are recited in the sub-claims.

### BRIEF DESCRIPTION OF THE DRAWINGS

The various features and advantages of the present invention and its preferred embodiments will now be described with reference to the accompanying drawings which are intended to illustrate and not to limit the scope of the present invention and in which:

FIG. 1 is a schematical overview of an installation according to the invention; and

FIGS. 2 to 5 are flowcharts explaining different scenarios when using the installation of FIG. 1.

### DETAILED DESCRIPTION OF PREFERRED EMBODIMENTS

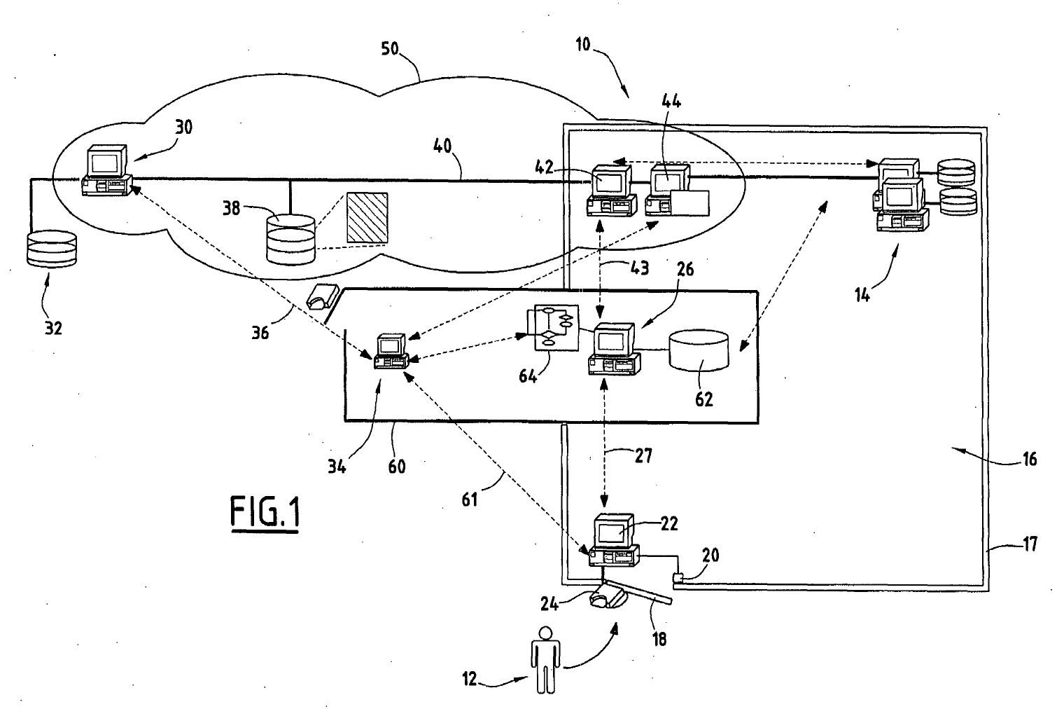

The installation 10 shown on FIG. 1 is suitable for a professional installation and particularly for post-production labs or a broadcasting center.

The installation is adapted to enable one or several users 12 to work on a digital content by using processing devices 14 in which the digital content to be processed is temporary stored.

In order to improve the treatment carried out by the processing devices 14, such as video processing for graphic effects or color corrections, the digital content is clear or raw when it is in the processing devices 14 which means that the digital content data are not encrypted or scrambled for example.

The processing devices 14 are within a restricted area 16 which is surrounded by a wall 17 and thus cannot be physically accessed by anybody except through an access way equipped with a gate 18 which is normally closed and locked.

The gate 18 is associated to a bridging lock 20 which is adapted to lock the gate 18 in a closed state or to unlock the gate 18, allowing a user to open the door and to enter into the restricted area 16.

The lock 20 is connected to a gate server 22 which is located in the restricted area 16.

The gate server 22 is connected to a token reader, for example a smart card reader 24 or an RFID tag reader adapted to receive and to read a token inserted by a user 12 intending to enter into the restricted area 16.

In the installation, each user 12 has a token, for example a smart card an RFID tag or an USB token, in which user authentication data including an identification data and an authorization level are stored. For example, the user authorization level is a number from 1 to 4, the higher the authorization level is, the more numerous the digital content which can be accessed are.

The gate server 22 is adapted to obtain the information stored in the token, each time a token is inserted in the reader 24. In addition, it includes a driving circuit for driving the lock 20 for switching it between its locked state and its unlocked state.

The gate server 22 is provided with an interface for connection to a gateway server 26. Through this interface, the gate server 22 is adapted to send authentication data read from a token by the reader 24 and to receive gate instructions from the gateway server through a link 27. The link 27 is a secure link, preferably a secured authenticated channel (SAC).

A usage rules database 64, in which the identification of users which are allowed to enter into the restricted area are stored, is used by the gateway server 26.

The gate server 22 drives the lock 22 according to the gate instructions received from the gateway server 26.

The installation includes means for providing digital content, by providing for example video or audio files to the processing devices 14, on request.

More precisely, the installation includes a main content server 30 which is arranged out of the restricted area 16.

The main content server 30 is connected to a clear content database 32 in which the clear digital content is stored. The clear content database 32 is located itself in a secured restricted area (with similar protections as the restricted area 16 for example).

The main content server 30 is adapted to implement a protection method for protecting clear content downloaded from the database 32. More precisely, the main content server 30 is in charge of scrambling and descrambling the clear digital content to produce protected digital content according to a method know per se.

For security reasons, the main content server is equipped with a secure processor or a secure token that comprises authentication keys.

In addition, the main content server 30 includes means for embedding digital content authentication data within the digital content itself when the clear digital content is scrambled.

The digital content authentication information is provided by a rights manager center 34 to which the main content server 30 is connected through a secured authenticated channel (SAC) 36.

For example, the digital content authentication information includes a security level which is for example a number from 1 to 4, the higher the security level, the more restricted the access to the digital content is.

A protected content database 38 is connected to the main content server 30 for storing the protected digital content produced by the main content server 30.

The content server 30 and the protected content database 38 are connected to the processing devices 14 through a secured communication channel 40 which goes through the wall 17 defining the restricted area 16.

A bridge server 42 is installed on the connection channel 40 at its entrance in the restricted area 16. The bridge server 42 is located within the restricted area. It is adapted to transfer to the main content server 30 a digital content request issued by a processing device 14 and to receive a corresponding protected digital content in return.

The bridge server 42 is connected to the gateway server 26 through a secured authenticated channel 43 to transfer to the gateway server 26 the digital content authentication data from the requested digital content and to receive in reply from the gateway server 26 bridge instructions which are a bridge flag indicating whether or not the digital content can be introduced into the restricted area 16 in view of its security level and of the people who are in the restricted area 16.

The bridge server 42 includes means for allowing the requested digital content to be transferred to the processing devices 14 if the bridge control instructions received from the gateway server 26 allow such a transmission and to block the transmission to the processing devices 14 if the bridge control instructions received from the gateway server 26 do not allow the transmission.

A local content server 44 is provided between the processing devices 14 and the bridge server 42.

The local content server 44 is a device in charge of scrambling and descrambling digital content. It is equipped with a secure processor or a secure token that comprises virtual domain authentications keys. It is also adapted to add extra information to be embedded as watermark information on the clear digital content for further security tracking. It is done through an internal watermark embedder in the server 44 during the descrambling operation. The watermark embedder is located in the local content server 44.

Relevant watermark information is provided by the gateway server 26 according to watermark rules.

As shown on FIG. 1, a virtual protected domain 50 is defined between the main content server 30 and the local content server 44. These two content servers 30 and 44 are identical on a functional point of view. They both contain a secure processor, preferably embedded inside the server, to carry out cryptographic operations for scrambling/descrambling digital contents sent to/retrieved from the virtual domain 50. In this virtual domain, the digital content is shared between different devices without the risk of being stolen since the digital content is protected.

On the contrary, the restricted area 16 defines a physical protected domain in which the digital content, whether protected or not, is accessible only for the users which are within the restricted area 16.

The processing devices 14 include means for treating the digital content and means for requesting digital content from the main content server 30 through the communication channel 40. It also includes means for sending treated digital content to the protected content database 38.

The rights management center 34 is adapted for granting, updating or revoking user rights used by gate server 22. It is connected to the gate server 22 by a secured authenticated channel 61.

The rights management center 34 is in charge of content rights attributions which are sent to the main content server 30 to be inserted in the protected digital content as digital content authentication data.

In addition, it is in charge of defining the usage rules implemented by the gateway server 26.

The gateway server 26 is adapted to send commands to the gate server 22 and to the bridge server 42. It includes an entry/exit database 62 and implements usage rules stored in the usage rules database 64.

The entry/exit database permanently keeps track of which digital contents and which users are in the restricted area 16. This also includes a tracing that shall be kept for further digital content watermarking for security tracking. More precisely, the identification data of the users and the digital contents which were in the restricted area 16 are stored together with the time at which the user or content entered and exited the restricted area.

The usage rules database 64 holds users and digital content rights authorization rules. It comprises usage rules for:

managing each users entry according to the clear digital contents located in the restricted area and the authentication data of the user intending to enter;

managing each digital content entry according to all users already in the restricted area 16 and the authentication data of the digital content intending to enter.

The usage rules database also includes the watermark rules for each digital content entry.

For example, the usage rules are as follows:

a user with an authorization level N is allowed to enter the restricted area 16 only if the clear digital content, currently registered inside the entry/exit database as being in the restricted area 16 does not comprise any digital content having a security level which is lower than the authorization level N;

a digital content with a security level N is allowed to enter the restricted area 16 only if current users registered inside the entry/exit database as being in the restricted area 16 does not comprise any user having an authorization level which is lower than the security level N,

digital content or user exits are unregistered in the entry/exit database, and

digital content or user entries are registered in the entry/exit database.

The rights management center 34, the gateway server 26, the entry/exit database 62 and the usage rules database 64 are located within a second restricted area 60 since confidential and/or critical data/algorithms are stored or computed inside these entities. Access to this second restricted area 60 is restricted to one or several privileged user(s) or administrator(s) who is(are) the only one(s) authorized to modify the data/algorithms stored in these entities. It is to be noted that the entities 34, 26, 62 and 64 located within this second restricted area may be used to guarantee the security of protected contents in several installations. In addition, even if this second restricted area 60 is represented on FIG. 1 partly inside and partly outside the restricted area 16, the entities of this second restricted area may be completely inside or completely outside the restricted area 16, provided that all communications between these entities and the outside servers are made through secure communication channels.

It is to be noted that the entities 22, 26, 42, 44 or 14 that have been described with reference to FIG. 1 can be implemented by individual servers/apparatuses as illustrated in the drawing but several entities can also be implemented by a single server.

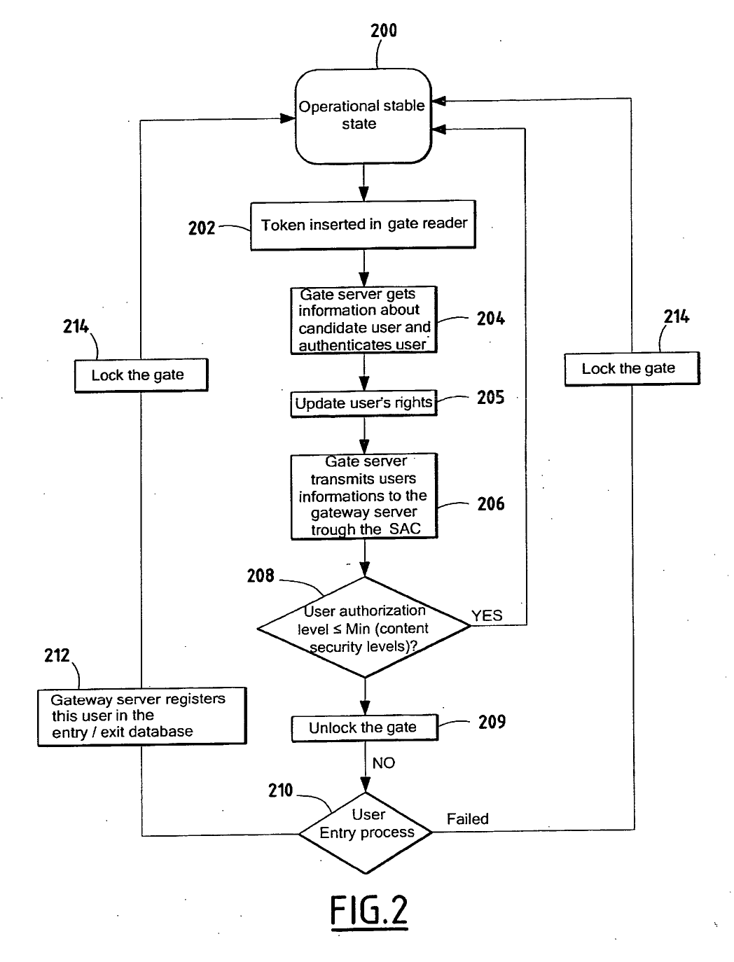

The working of the installation will be explained with reference to FIGS. 2 to 5.

Before using the installation, an initialization process is carried out.

A configuration of the usage rules database 64 is done first. It consists in configuring and storing all granted authorization levels and security levels for all users and digital content with respect to each other.

The gateway server and its embedding control algorithm feature is in charge to further compute these authorizations. Entry/exit database 62 is reset. Digital content and user rights are considered up to date since digital content rights attribution are managed by the main content server 30 and the user rights are given by the authority in charge of distributing the token.

With the exception of the situation where a user intends to enter or exit the restricted area or when a digital content intends to enter or exit the same restricted area, the installation is otherwise in an operational stable state 200. In this stable state, the installation is ready to receive a user entry request or digital content download request. The entry/exit database contains the user and digital content authentication data for all users and digital content of the restricted area 16.

FIG. 2 shows a user entry procedure.

The procedure is carried out to allow the new user to enter and process each clear digital content in the restricted area 16.

A user stands in front of the gate 18. He inserts his secure token (e.g smart card) into the token reader 24 at step 202. The token is preferably swallowed by the reader 24 before doing further operation.

At step 204, the gate server 22 reads the token information and authenticates the user. The information is sent to the gateway server 26.

At step 205, the gate server 22 also sends user authentication data to the right management center 34 through the SAC 61. The right management center checks the rights update and returns back through the same channel updated rights or revocations for the token currently inserted in the reader 24.

The gateway server 26 receives the user authentication data through the link 27 at step 206.

At step 208, the rights authorization granted for this current user is extracted from the usage rules database 64.

The internal control algorithm of the gateway server 26 computes current user rights. It is done with respect to current digital content located in the physical domain maintained by the entry/exit database and associated user usage rights located in the usage rules database 64. More precisely, in the example, the authorization level of the candidate user is compared to the minimum of the security levels N of the contents which are downloaded in the restricted area 16 at step 208.

If there is no content in the restricted area having a security level N higher than the authorization level of the candidate user (response “NO” to the test 208), the gateway server 26 sends back to the gate server 22 a gate instruction (open gate) through the same secure channel 27 and the lock 20 is unlocked at step 209. Otherwise (response “YES” to the test 208), the gate server 22 receives a refusal information and informs the user that he is not allowed to enter the restricted area. The token is returned and the installation goes back to the operational stable state 200.

Assuming that the gate is unlocked according gate server command (step 209), the user can enter the restricted area 16. At step 210, it is checked if the user entry process is completed. For example, an air lock system where user shall also insert his secure token inside the lock chamber is provided. If the user is not entered within a fixed time period, the entry process is considered as aborted.

Another system can be deployed based on a swallowed token. In this case, the user gets back his token only when he is completely in the physical domain.

When the procedure is completed, the gateway server registers at step 212 the current user on the entry/exit database 62.

In any case, the gate is locked at step 214 and the installation goes back to the operational stable state 200.

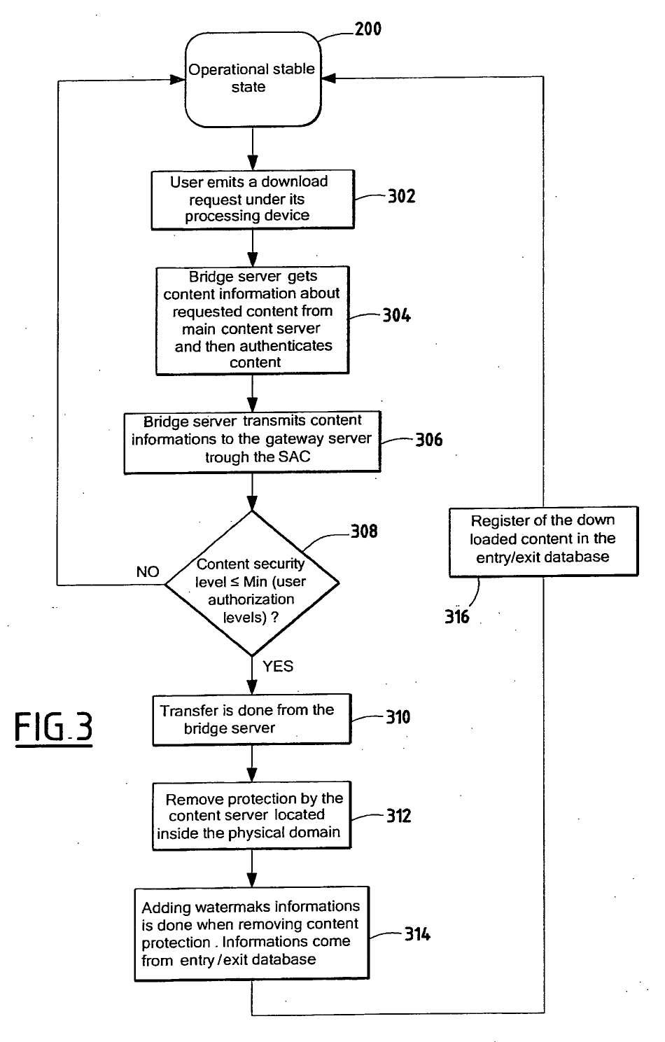

FIG. 3 shows a digital content entry procedure.

The procedure is carried out to ensure that all users in the restricted area 16 hold rights to process the candidate digital content.

At step 302, a user which is in the restricted area 16 sends a digital content download request from a processing device 14 to the content bridge server 42.

At step 304, the bridge server 42 receives a content download request intended to enter the restricted area 16 and gets digital content authentication data from the main content server 30 through the secure channel 40 of the virtual domain.

The gateway server 26 receives the digital content authentication data including security level N from the bridge server 42 through the bridge control secured authenticated channel (SAC) 43 at step 306.

At step 308, the internal control algorithm of the gateway server 26 computes the security level N of the requested digital content with respect to authorization levels of the users located in the restricted area 16.

Content bridge server 42 acts as a digital content firewall. In the example, the security level of the requested digital content is compared to the minimum of the authorization levels of the users which are within the restricted area 16 at step 308.

If at least one user has an authorization level which is lower than the security level of the requested digital content (response “NO” to the test 308), then the requested digital content cannot enter the restricted area and the installation goes back to the operational stable state 200.

If there is no user having a authorization level which is lower than the candidate digital content security level (response “YES” to the test 308), an authorization is return back from the gateway server 26 with the same secured authenticated channel (SAC) 43. The protected digital content is downloaded at step 310 in the restricted area 16 to the local content server 44. The local content server 44 removes the digital content protection by descrambling the data at step 312. At step 314, watermarks information are added in the clear digital content by the local content server 44. The watermarks contain for example the time and the identification of the user who has requested the digital content together with the identification of the other people who are in the restricted area. Then, the clear digital content is pushed to the relevant processing device 14.

When process is completed, the gateway server 26 registers the current digital content on the entry/exit database 62 at step 316.

The user is then able to process the clear digital content under its processing device 14. Then, the installation goes back to the operational stable state 200.

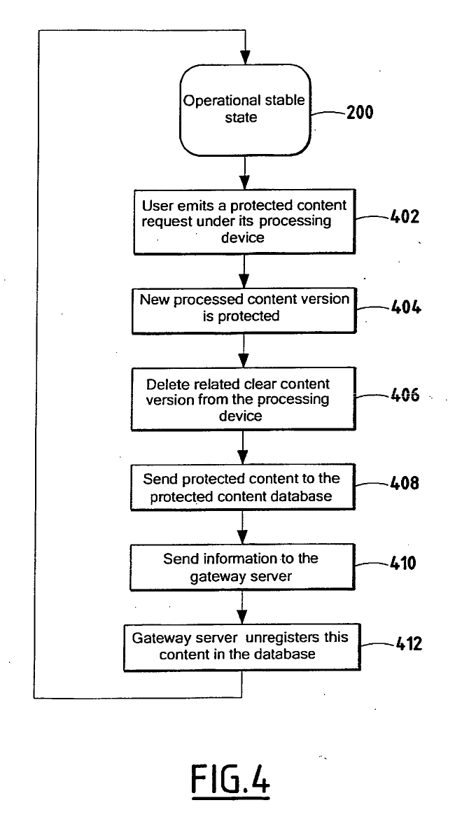

FIG. 4 shows digital content exit procedure.

A user selects the clear digital content which he has processed to protect it and to save it in the protected content database 38.

The processing device 14 sends this request to the local content server 44 at step 402.

The local content server 44 creates a new version identifier and makes a new scrambled version of the digital content at step 404. Upon content server notification, the processing device automatically deletes the clear digital content reference at step 406. It sends the digital content through the bridge server 42 out of the restricted area to the protected content database 38 through the secured authenticated channel (SAC) 40 at step 408.

The local content server 44 sends the information through the bridge server 42 to the gateway server 26 at step 410.

When the process is completed, the gateway server 26 deletes the current digital content from the entry/exit database 62 at step 412 and the installation goes back to the operational stable state 200.

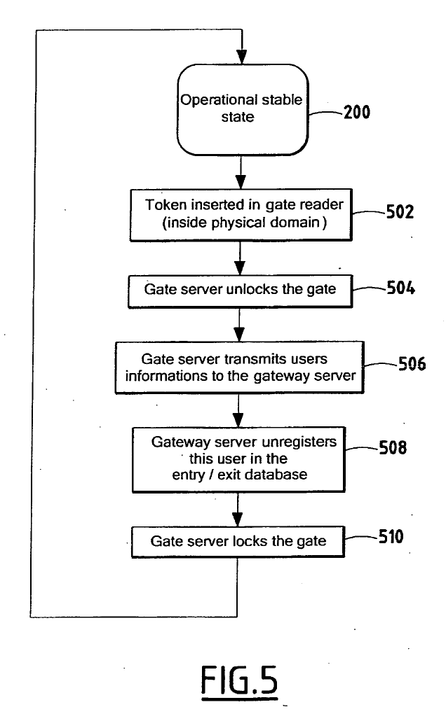

FIG. 5 shows user exit procedure.

The user inserts his token in the token reader 24 managed by the gate server 22 at step 502. It is to be noted that the token reader 24 has a slot available inside the restricted are 16 and a slot available outside the restricted area.

The gate server 22 unlocks the gate and opens the gate 18 at step 504. The users take its token back from the token reader and get out of the physical restricted area 16.

At step 506, the gate server 22 notifies the gateway server 26 that the user is out of the restricted area.

When the process is completed, the gateway server 26 deletes the registration of the current user from the entry/exit database 62 at step 508. The gate server 22 locks the gate 18 at step 510 and the installation goes back to the operational stable state 200.

Thanks to the procedure implemented, a security tracking process can be achieved in the case where a known clear digital content was leaked by retrieving the digital content for further analysis.

A watermark detection program is applied to that digital content.

The watermark information (digital content entry time, digital content requester ID) is computed and compared to information located in the entry/exit database or on a backup.

All users who were present in the restricted area and user which requests the download of the digital content can be retrieved.

Legal pursuits can then be issued.

The invention prevents content leaks since everything is tracked and imposes a dissuasive measure on the malicious intruder/attacker.

In an alternative embodiment (not shown on the drawings), the content remains protected until the processing devices 14. In this embodiment, the virtual protected domain 50 encompasses the processing devices and the content server entity is embedded inside each processing device 14 which is linked through a SAC to the rights management center 34. A watermark insertion device is also located inside the processing device and token readers are provided with each processing device. When a user wants to process a content in clear on one processing device, he has to insert his token in the token reader of this processing device.

This embodiment improves the system and reinforces its security thanks to the following:

content entry requests can be linked to each individual user thanks to individual tokens inserted in each processing device;

watermark information taken from the individual token can be embedded inside the clear content by the processing device (which descrambles the protected content);

clear content available inside a processing device can be linked to the individual token presence. When the user removes his token from the processing device token reader, the processing device can automatically scramble the content and then remove the local clear content from its local storage means without user's intervention;

since the user exit process requires token insertion at the gate token reader 24, when the user wants to leave the physical restricted area 16, he shall first remove his token from the processing device to be able to insert it at the gate token reader 24.

With this embodiment, each operation of a user on a content is traced inside the infrastructure as well as inside the content itself (thanks to the watermark). When a user removes his token or leaves the physical restricted area, the system guarantees that no clear content remains inside a processing device without user's intervention.

While the preferred embodiment described hereinbefore discloses digital content as video data, it should be noted that the invention may also be used with other kinds of digital content such as for example computer files like files used with word processors and spreadsheet programs.

The above the specification, examples and drawings provide a complete description of the manufacture and use of the composition of the invention. Since many embodiments of the invention can be made without departing from the spirit and scope of the invention, the invention resides in the claims herein after appended.

1. Installation for protected access to a digital content comprising:
a candidate user identification means,
a lock adapted to lock or unlock an access gate to a restricted area containing at least a processing device for processing a digital content,
a bridge server adapted to allow or refuse a candidate content intended to be downloaded by a processing device to be provided to a user, and
a gateway server adapted to implement rules for driving the bridge server and the lock to allow or refuse the entrance of a candidate user or a candidate content into the restricted area depending on the users and the digital content already entered in the restricted area.

2. Installation according to claim 1, wherein the rules implemented by the gateway server are adapted for the gateway server to:
1) drive the unlocking of the lock for allowing an identified candidate user to enter the restricted area only if the digital content entered in the restricted area through the bridge server can be accessed by the candidate user according to the rules, and
2) drive the bridge server to allow a candidate digital content to be provided to a processing device only if all the users previously identified by the user identification means and having entered the restricted area are allowed to access to the candidate digital content according to the rules.

3. Installation according to claim 1, further comprising means for descrambling a digital content entering the restricted area and for scrambling a processed digital content exiting the restricted area.

4. Installation according to claim 1, further comprising means for adding a watermark for security tracking into a digital content entering the restricted area.

5. Installation according to claim 1, further comprising means for storing information relating to the users and the digital content which have been simultaneously in the restricted area.

6. Installation according to claim 1, wherein each user is featured to an authorization level, each digital content is featured by a security level and in that the rules implemented by the gateway server are defined based on the authorization levels and the security levels.

7. Installation according to claim 1, wherein each digital content comprises an attribute used by the gateway server for implementing the rules, said attribute being contained in the digital content and the bridge server includes means for retrieving the attribute in the digital content.

8. Installation according to claim 1, further comprising a entry/exit database in which the digital content and the users currently in the restricted area are registered and the gateway server includes means for registering in the entry/exit database the digital content and the users entering the restricted area and for unregistering in the entry/exit database the digital content and the users exiting the restricted area.

9. Installation according to claim 1, wherein the bridge server comprises means for automatically deleting a digital content from each processing unit when the digital content exits the restricted area.

10. Method for protected access by a user to a digital content comprising the steps of:
registering the users and the digital content already entered in a restricted area provided with a lock adapted to lock or unlock an access gate to the restricted area containing at least a processing device for processing a digital content, and with a bridge server adapted to allow or refuse a candidate digital content intended to be downloaded by a processing device to be provided to a user,
identifying a candidate user or a candidate content intending to enter the restricted area,
driving the bridge server and the lock to allow or refuse the entrance of a candidate user or a candidate digital content in the restricted area depending on the users and the digital content already entered in the restricted area.

11. Gateway server installation for protected access to a digital content comprising:
means for receiving a candidate user identification,
means for implementing rules for driving the bridge server and the lock to allow or refuse the entrance of a candidate user or a candidate digital content depending on the users and the digital content already entered in the restricted area, the lock being adapted to lock or unlock an access gate to a restricted area containing at least a processing device for processing a digital content, and the bridge server being adapted to allow or refuse a candidate digital content intended to be downloaded by a processing device to be provided to a user.
